(19) United States
(12) Patent Application Publication
(10) Pub. No.: US 2021/0229483 A1
(43) Pub. Date: Jul. 29, 2021

(54) METHOD AND APPARATUS FOR OPTICAL CLOAKING

(71) Applicant: Oxford University Innovation Limited, Oxford (GB)

(72) Inventors: Chloe Ceren TARTAN, Oxford (Oxfordshire) (GB); John Sandford O'NEILL, Oxford (Oxfordshire) (GB); Patrick SALTER, Oxford (Oxfordshire) (GB); Stephen MORRIS, Oxford (Oxfordshire) (GB); Miha RAVNIK, Oxford (Oxfordshire) (GB); Martin BOOTH, Oxford (Oxfordshire) (GB); Steve ELSTON, Oxford (Oxfordshire) (GB)

(21) Appl. No.: 17/051,903

(22) PCT Filed: Apr. 25, 2019
(86) PCT No.: PCT/GB2019/051160

§ 371 Date: Oct. 30, 2020

(30) Foreign Application Priority Data
May 3, 2018 (GB) 1807323.9

(51) Int. Cl. B42D 25/364; G02F 1/1333; G02F 1/1337; G06K 9/62; G06K 19/06

(52) U.S. Cl. CPC B42D 25/364; G02F 1/133365; G02F 1/133784; G02F 1/133374; B42D 25/41; G06K 19/06028; G06K 19/06037; G06K 2209/03; G06K 9/6201

(57) ABSTRACT

A method is disclosed for authenticating a product. The method comprises: receiving a verification code associated with the product; applying an electric field to a liquid crystal device (100) located in or on the product, the liquid crystal device (100) comprising: a first substrate (105); a second substrate (110) spaced apart from the first substrate (105); a liquid crystal composition (115) located between the first substrate (105) and the second substrate (110); wherein the liquid crystal composition (115) comprises one or more regions (120) of polymerised liquid crystal composition; and a first electrode (125) and a second electrode (130) configured to apply the electric field; comparing a display output by the liquid crystal device (100) in response to the application of the electric field to the verification code associated with the product; wherein, if the display output by the liquid crystal device (100) matches the verification code associated with the product, the product is authenticated.

### TECHNICAL FIELD

The present invention relates to liquid crystal devices, and in particular but not exclusively, to a method for optically cloaking polymeric structures using liquid crystal devices.

### BACKGROUND

Optical cloaking is a phenomenon traditionally associated with artificially structured metamaterials that can manipulate electromagnetic waves to render an object invisible. The notion of optical cloaking typically involves hiding an object by distorting the paths of electromagnetic waves using transformational optics. However, to realise the effects of transformational optics, artificially sculptured metamaterials with unique physical properties are generally required. Techniques such as electron beam lithography and direct laser writing are often used to manipulate the optical and electrical properties of photonics materials on the micro and nanometer scale.

Alternative methods of optical cloaking are desired which provide the benefits of optical cloaking without the laborious manufacturing processes typically associated with the production of metamaterials for use at optical frequencies, which can be particularly challenging because of the length scales involved.

“Generation of 3-dimensional polymer structures in liquid crystalline devices using direct laser writing” (C. C. Tartan et al, RSC Adv., 2017, 7, 507—“Tartan et al”) describes fabricating, using direct laser writing, of polymeric structures in pi-cells (comprising substrates rubbed in parallel directions). The polymeric structures can be rendered optically “invisible” (i.e., within a region bounded by the outermost polymeric structures) by the application of an electric field of the same strength as the strength of the electric field under which the polymeric structures were polymerised.

### SUMMARY

According to a first aspect of the invention, there is provided a method of authenticating a product. The method comprises receiving a verification code associated with the product; applying an electric field to a liquid crystal device located in or on the product; comparing a display output by the liquid crystal display in response to the application of the electric field to the verification code associated with the product; wherein, if the display output by the liquid crystal device matches the verification code associated with the product, the product is authenticated. The liquid crystal device comprises: a first substrate; a second substrate spaced apart from the first substrate; a liquid crystal composition located between the first substrate and the second substrate, wherein the liquid crystal composition comprises one or more regions of polymerised liquid crystal composition; and a first electrode and a second electrode configured to apply the electric field.

Alternatively, rather than comparing the display output by the liquid crystal device to a verification code associated with the product, the product may be authenticated if there is any change in the display output by the liquid crystal device on the application of an electric field to the liquid crystal device. If no parties aside from the manufacturer and the party which the manufacturer is supplying are aware that a security marking exists, then this simple method of authentication may be appropriate.

Utilising a liquid crystal device with polymerised regions of liquid crystal composition in a method of product authentication enables a covert security marking to be used that is only readable on application of an electric field to the liquid crystal device. This may protect against easy forgery of products protected using such a liquid crystal device.

In some embodiments, the first electrode and the second electrode may be configured to apply the electric field across the device (i.e., orthogonal to the first substrate and the second substrate). In other embodiments, the first electrode and the second electrode may be configured to apply the electric field in the plane of the device (i.e., parallel to the first substrate and the second substrate). In some embodiments, the first electrode and/or the second electrode may each comprise a plurality of electrodes. In some embodiments, the first electrode and/or the second electrode may comprise interdigitated electrodes.

In an embodiment, the liquid crystal composition may comprise a nematic liquid crystal material with either a positive or negative dielectric anisotropy. In alternative embodiments, the liquid crystal composition may comprise any liquid crystal material, for example, chiral nematic liquid crystal and smectic A liquid crystal. In some embodiments, the liquid crystal composition may comprise a homeotropic alignment (i.e., wherein molecules in the liquid crystal composition are aligned orthogonally to the first substrate and/or the second substrate). In such embodiments, the liquid crystal composition may comprise a hybrid liquid crystal alignment (i.e., wherein molecules in the liquid crystal composition are aligned homeotropically at one of the first substrate and the second substrate, and are aligned homogeneously or parallel to the plane of the substrate at the other of the first substrate and the second substrate).

In an embodiment, the first substrate may be rubbed in a first direction, and the second substrate may be rubbed in a second direction, the first direction being anti-parallel to the second direction. Anti-parallel rubbing directions on the first substrate and the second substrate may provide enhanced optical invisibility of the polymerised regions relative to the surrounding bulk liquid crystal composition under the application of a pre-determined electric field strength.

In an embodiment, the first substrate may be rubbed in a first direction, and the second substrate may be rubbed in a second direction, the first direction being parallel to the second direction.

In other embodiments, the first substrate may be rubbed in a first direction, and the second substrate may be rubbed in a second direction at any orientation to the first direction. The first direction and the second direction may be skewed by a few degrees (e.g., between ≥0° and ≤10° or ≥0°≤45°) relative to one another. The first direction and the second direction may be oriented approximately 45° to one another, yielding a weakly twisted liquid crystal structure. The first direction and the second direction may be substantially orthogonal (i.e., approximately 90°), yielding a twisted structure of the liquid crystal. The first direction may be oriented at an angle greater than 90° (e.g., 180°, 240°, 270°) with respect to the second direction, yielding a super-twisted liquid crystal structure.

In an embodiment, the polymerised regions may comprise or consist of pillars or columns extending partially or fully between the first substrate and the second substrate. In alternative embodiments, the polymerised regions may comprise or consist of walls extending partially or fully between the first substrate and the second substrate.

In an embodiment, the polymerised regions may be polymerised by direct laser writing. The direct laser writing may be aberration-corrected direct laser writing. In other embodiments, the polymerised regions may be polymerised by conventional mask-based lithography.

In an embodiment, the polymerised regions may be spaced apart by a distance of at least 2 μm, and in an alternative embodiment may be spaced apart by a distance of at least 5 μm. Adequate spacing of the polymerised regions may allow for improved optical properties of the polymerised regions under the application of an electric field. In particular, localised effects due to the interaction between the polymerised regions and the surrounding liquid crystal material may be reduced or removed by adequately spacing the polymerised regions.

In an embodiment, one or more of the polymerised regions may be polymerised under the application of an electric field. Different polymerised regions may be polymerised under the application of different electric field strengths. This may allow for reconfigurable displays to be output by the liquid crystal device under the application of different electric field strengths.

In an embodiment, the polymerised regions may be configured to be optically invisible under the application of a pre-determined electric field strength. The polymerised regions may be configured to be optically invisible under both polarised light and unpolarised light. This may allow for the polymer structures to be selectively made to appear and disappear under the application of an electric field.

In an embodiment, the verification code may be one of a bar code, a QR (quick response) code, a pattern or an image. Alternatively, any display that may be output by the liquid crystal device may be utilised as the verification code.

In an embodiment, the verification code may be a sequence of verification codes, and the electric field may be a sequence of electric fields. This may increase the complexity of the authentication process, thereby increasing the difficulty of forgery of the product to be authenticated.

According to a second aspect of the invention, there is provided a use of a liquid crystal device as a security marking, the liquid crystal device comprising: a first substrate; a second substrate spaced apart from the first substrate; a liquid crystal composition located between the first substrate and the second substrate, wherein the liquid crystal composition comprises one or more regions of polymerised liquid crystal composition; and a first electrode and a second electrode configured to apply an electric field; wherein the security marking is configured to output a display under the application of an electric field.

In some embodiments, the first electrode and the second electrode may be configured to apply the electric field across the device (i.e., orthogonal to the first substrate and the second substrate). In other embodiments, the first electrode and the second electrode may be configured to apply the electric field in the plane of the device (i.e., parallel to the first substrate and the second substrate). In some embodiments, the first electrode and/or the second electrode may each comprise a plurality of electrodes. In alternative embodiments, the first electrode and/or the second electrode may comprise interdigitated electrodes.

In an embodiment, the liquid crystal composition may comprise a nematic liquid crystal material with either a positive or negative dielectric anisotropy. In alternative embodiments, the liquid crystal composition may comprise any liquid crystal material, for example, chiral nematic liquid crystal and smectic A liquid crystal. In some embodiments, the liquid crystal composition may comprise a homeotropic alignment (i.e., wherein molecules in the liquid crystal composition are aligned orthogonally to the first substrate and/or the second substrate). In such embodiments, the liquid crystal composition may comprise a hybrid liquid crystal alignment (i.e., wherein molecules in the liquid crystal composition are aligned homeotropically at one of the first substrate and the second substrate, and are aligned homegeneously or parallel to the plane of the substrate at the other of the first substrate and the second substrate).

In an embodiment, the first substrate may be rubbed in a first direction, and the second substrate may be rubbed in a second direction, the first direction being anti-parallel to the second direction. Anti-parallel rubbing directions on the first substrate and the second substrate may enhance optical invisibility of the polymerised regions relative to the entirety of the surrounding bulk liquid crystal composition under the application of an electric field of pre-determined strength.

In an embodiment, the first substrate may be rubbed in a first direction, and the second substrate may be rubbed in a second direction, the first direction being parallel to the second direction.

In other embodiments, the first substrate may be rubbed in a first direction, and the second substrate may be rubbed in a second direction at any orientation to the first direction. The first direction and the second direction may be skewed by a few degrees (e.g. between ≥0° and ≤10° or ≥0°≤45°) relative to one another. The first direction and the second direction may be oriented approximately 45° to one another, yielding a weakly twisted liquid crystal structure. The first direction and the second direction may be substantially orthogonal (i.e., approximately 90°), yielding a twisted structure of the liquid crystal. The first direction may be oriented at an angle greater than 90° (e.g., 180°, 240°, 270°) with respect to the second direction, yielding a super-twisted liquid crystal structure.

In an embodiment, the polymerised regions may comprise or consist of pillars or columns extending partially or fully between the first substrate and the second substrate. In alternative embodiments, the polymerised regions may comprise or consist of walls extending partially or fully between the first substrate and the second substrate.

In an embodiment, the polymerised regions may be spaced apart by a distance of at least 2 μm, and in an alternative embodiment may be spaced apart by a distance of at least 5 μm. Adequate spacing of the polymerised regions may allow for improved optical invisibility of the polymerised regions under the application of an electric field. In particular, localised effects due to the interaction between the polymerised regions and the surrounding liquid crystal material may be reduced or removed by adequately spacing the polymerised regions.

In an embodiment, one or more of the polymerised regions may be polymerised under the application of an electric field. Different polymerised regions may be polymerised under the application of different electric field strengths. This may result in different local molecular orientation directions (i.e., director profiles) being locked in or retained for polymerised regions polymerised under the application of different electric field. This may allow for reconfigurable displays to be output by the liquid crystal device under the application of different electric field strengths.

In an embodiment, the polymerised regions may be configured to be optically invisible under the application of a pre-determined electric field strength. The polymerised regions may be configured to be optically invisible under both polarised light and unpolarised light. This may allow for the polymer structures to be selectively made to appear and disappear under the application of an electric field.

In an embodiment, the security marking may be configured to display a verification code under the application of an electric field. In some embodiments, the verification code may be one of a bar code, a QR code, a pattern or an image. Alternatively, any display that may be output by the liquid crystal device may be utilised as the verification code.

In an embodiment, the verification code may be a sequence of verification codes, and the electric field may be a sequence of electric fields. This may increase the complexity of the authentication process, thereby increasing the difficulty of forgery of the product to be authenticated. In embodiments in which the liquid crystal device comprises a hybrid liquid crystal alignment, the difficulty of forgery may be increased further.

According to a third aspect of the invention, there is provided a liquid crystal device comprising: a first substrate rubbed in a first direction; a second substrate spaced apart from the first substrate and rubbed in an anti-parallel direction to the first substrate; a liquid crystal composition located between the first substrate and the second substrate, wherein the liquid crystal composition comprises one or more regions of polymerised liquid crystal composition; and a first electrode and a second electrode configured to produce an electric field.

Anti-parallel rubbing directions on the first substrate and the second substrate may enhance optical invisibility of the polymerised regions relative to the surrounding bulk liquid crystal composition under the application of a pre-determined electric field strength. In contrast, optical invisibility of a liquid crystal device utilising parallel rubbing directions for a first substrate and a second substrate may be limited to a region bounded by polymer structures written into the parallel-rubbed liquid crystal device.

In an embodiment, the polymerised regions may comprise or consist of pillars or columns extending partially or fully between the first substrate and the second substrate. In alternative embodiments, the polymerised regions may comprise or consist of walls extending partially or fully between the first substrate and the second substrate.

In an embodiment, the polymerised regions may be spaced apart by a distance of at least 2 μm, and in an alternative embodiment may be spaced apart by a distance of at least 5 μm. Adequate spacing of the polymerised regions may allow for improved optical invisibility of the polymerised regions under the application of an electric field. In particular, localised effects due to the interaction between the polymerised regions and the surrounding liquid crystal material may be reduced or removed by adequately spacing the polymerised regions.

In an embodiment, one or more of the polymerised regions may be polymerised under the application of an electric field. Different polymerised regions may be polymerised under the application of different electric field strengths. This may allow for reconfigurable displays to be output by the liquid crystal device under the application of different electric field strengths.

In an embodiment, the polymerised regions may be configured to be optically invisible under the application of a pre-determined electric field strength. The polymerised regions may be configured to be optically invisible under both polarised light and unpolarised light. This may allow for the polymer structures to be selectively made to appear and disappear under the application of an electric field.

In an embodiment, the liquid crystal composition may comprise a nematic liquid crystal material with either a positive or negative dielectric anisotropy. In alternative embodiments, the liquid crystal composition may comprise any liquid crystal material, for example, chiral nematic liquid crystal and smectic A liquid crystal. In some embodiments, the liquid crystal composition may comprise a homeotropic alignment (i.e., wherein molecules in the liquid crystal composition are aligned orthogonally to the first substrate and/or the second substrate). In such embodiments, the liquid crystal composition may comprise a hybrid liquid crystal alignment (i.e., wherein molecules in the liquid crystal composition are aligned homeotropically at one of the first substrate and the second substrate, and are aligned homogeneously or parallel to the plane of the substrate at the other of the first substrate and the second substrate).

According to a fourth aspect of the invention, there is provided a method of electrically controlling optical visibility of polymer structures, the method comprising applying an electric field to a liquid crystal device. The liquid crystal device comprises: a first substrate rubbed in a first direction; a second substrate spaced apart from the first substrate and rubbed in an anti-parallel direction to the first substrate; a liquid crystal composition located between the first substrate and the second substrate, wherein the liquid crystal composition comprises one or more regions of polymerised liquid crystal composition forming polymer structures; and a first electrode and a second electrode configured to apply the electric field. The polymer structures are configured to be optically invisible under the application of a pre-determined electric field strength.

In some embodiments, the first electrode and the second electrode may be configured to apply the electric field across the device (i.e., orthogonal to the first substrate and the second substrate). In other embodiments, the first electrode and the second electrode may be configured to apply the electric field in the plane of the device (i.e., parallel to the first substrate and the second substrate). In some embodiments, the first electrode and/or the second electrode may each comprise a plurality of electrodes. In alternative embodiments, the first electrode and/or the second electrode may comprise interdigitated electrodes.

The optical visibility of polymer structures may be improved in a liquid crystal device comprising a first substrate and a second substrate rubbed in anti-parallel directions. The optical invisibility may be relative to the bulk liquid crystal composition surrounding the polymer structures in the device, and may not be limited to the region bounded by the polymer structures (as for parallel-rubbed liquid crystal devices).

In an embodiment, one or more of the polymerised regions may be polymerised under the application of an electric field. Different polymerised regions may be polymerised under the application of different electric field strengths. This may result in different local molecular orientation directions (i.e., director profiles) being locked in or retained for polymerised regions polymerised under the application of different electric fields. This may allow for reconfigurable displays to be output by the liquid crystal device under the application of different electric field strengths.

In an embodiment, the polymerised regions may be configured to be optically invisible under the application of a pre-determined electric field strength. The polymerised regions may be configured to be optically invisible under both polarised light and unpolarised light. This may result in the polymer structures being selectively made to appear and disappear under the application of an electric field.

In an embodiment, the polymerised regions may comprise or consist of pillars or columns extending partially or fully between the first substrate and the second substrate. In alternative embodiments, the polymerised regions may comprise or consist of walls extending partially or fully between the first substrate and the second substrate.

In an embodiment, the polymerised regions may be spaced apart by a distance of at least 2 μm, and in an alternative embodiment may be spaced apart by a distance of at least 5 μm. Adequate spacing of the polymerised regions may improve optical invisibility of the polymerised regions under the application of an electric field. In particular, localised effects due to the interaction between the polymerised regions and the surrounding liquid crystal material may be reduced or removed by adequately spacing the polymerised regions.

In an embodiment, the liquid crystal composition may comprise a nematic liquid crystal material with either a positive or negative dielectric anisotropy. In alternative embodiments, the liquid crystal composition may comprise any liquid crystal material, for example, chiral nematic liquid crystal and smectic A liquid crystal. In some embodiments, the liquid crystal composition may comprise a homeotropic alignment (i.e., wherein molecules in the liquid crystal composition are aligned orthogonally to the first substrate and/or the second substrate). In such embodiments, the liquid crystal composition may comprise a hybrid liquid crystal alignment (i.e., wherein molecules in the liquid crystal composition are aligned homeotropically at one of the first substrate and the second substrate, and are aligned homogeneously or parallel to the plane of the substrate at the other of the first substrate and the second substrate).

According to a fifth aspect of the invention, a verification device for verifying a security marking comprising a liquid crystal device (as described above) is provided, the verification device comprising: an optical detector configured to detect a display output by the liquid crystal device; a memory containing a verification code associated with the security marking; a processor, the processor configured to perform a comparison between the display output by the liquid crystal device and the verification code stored in the memory, and verify the security marking if the display output by the liquid crystal device matches the verification code stored in the memory.

In an embodiment, the optical detector may be one of a camera, a charge-coupled device, a raster-scanning laser detector or a photodiode detector.

In an embodiment, the verification device may comprise a power source configured to supply power to the liquid crystal device in order for the liquid crystal device to output a display. Supplying power to the liquid crystal device using the verification device may remove the need to provide the liquid crystal device with a separate power supply to be incorporated into or onto a product to be marked using the liquid crystal device. The implementation of a liquid crystal device as a security marking into a product may therefore be simplified. There may also be no requirement to remove or replace a power source for the liquid crystal device of the security marking if power is supplied to it via the verification device, which may increase the ease of maintenance of the liquid crystal device.

### BRIEF DESCRIPTION OF THE DRAWINGS

The invention will now be described by way of example with reference to the accompanying drawings in which:

FIG. 1 shows a schematic of a liquid crystal device with anti-parallel rubbing directions;

FIG. 2 shows a direct laser writing system, and schematics of the fabrication of polymer structures in a liquid crystal device;

FIG. 3 shows a scanning electron micrograph of polymer structures in a liquid crystal device;

FIG. 4 shows optical polarising microscopy images and simulated images of a polymer structure written in a liquid crystal device at 4 V, and schematics of the liquid crystal device under various applied electric field strengths;

FIG. 5 shows optical polarising microscopy images and simulated images of an array of polymer structures written in a liquid crystal device at various electric field strengths, and schematics of the liquid crystal device under various applied electric field strengths;

FIG. 6 shows images of an array of polymer structures written in a liquid crystal device at various electric field strengths under both polarised light and unpolarised light, and colourmap charts indicating the relative visibility of polymer structures at various applied electric field strengths;

FIG. 7 shows an array of polymer structures written in a liquid crystal device in a checkerboard pattern at various electric field strengths, and the optical behaviour of the array of polymer structures under various applied electric field strengths;

FIG. 8 shows an image of a micro-bicycle written in a liquid crystal device;

FIG. 9 shows a reconfigurable emoticon and the New College Crest, Oxford University, written in liquid crystal devices, under various applied electric field strengths;

FIG. 10 shows polymer structures written in a liquid crystal device forming part of the prior art;

FIG. 11 shows a QR (quick response) code written in a liquid crystal device, and schematics of an inverted QR code design;

FIG. 12 shows a plurality of QR codes written in a liquid crystal device at a plurality of polymer structure spacings;

FIG. 13 shows a QR code written at 0 V with a polymer structure spacing of 3 μm;

FIG. 14 shows a series of images of a QR code at a range of applied electric field strengths; and

FIG. 15 shows a schematic of a verification device configured to detect and verify a security marking comprising a liquid crystal device.

Like reference numbers and designations in the various drawings indicate like elements.

Features which are described in the context of separate aspects and embodiments of the invention may be used together and/or be interchangeable wherever possible.

Similarly, where features are, for brevity, described in the context of a single embodiment, these may also be provided separately or in any suitable sub-combination. Features described in connection with the method may have corresponding features definable with respect to the liquid crystal device and use of the liquid crystal device, and these embodiments are specifically envisaged.

### DETAILED DESCRIPTION

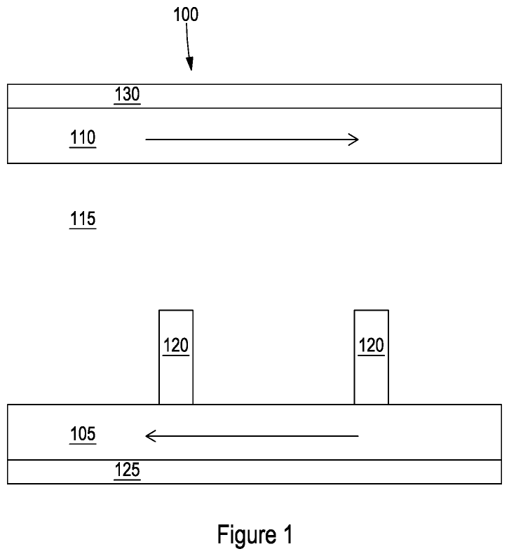

FIG. 1 shows a schematic of a liquid crystal device 100 used in the examples described herein. The liquid crystal device 100 comprises a first substrate 105 rubbed in a first rubbing direction, and a second substrate 110 spaced apart from the first substrate and rubbed in a second rubbing direction, wherein the second rubbing direction is anti-parallel to the first rubbing direction. The anti-parallel rubbing directions of the first substrate 105 and the second substrate 110 are indicated by the arrows located on the first substrate 105 and the second substrate 110 respectively. The liquid crystal device 100 also comprises a liquid crystal composition 115 located between the first substrate 105 and the second substrate 110. One or more regions of the liquid crystal composition are polymerised to form polymerised regions 120. The polymerised regions 120 may be in the form of polymer structures (e.g. polymer pillars, polymer walls). A first electrode 125 and a second electrode 130 are configured to apply an electric field between the first substrate 105 and the second substrate 110.

The liquid crystal device used in the examples described herein comprises transparent substrates (spaced apart by a distance of 20 μm) with planar alignment layers and transparent electrodes. Glass was used for the transparent substrates, but any other transparent material may also be used. The alignment layers are rubbed in anti-parallel directions. Polyimide was used for the alignment layers, but other compositions may also be used. Located between the glass substrates is a liquid crystal composition comprising a nematic liquid crystal host, and a mixture of reactive mesogen and photo-initiator dispersed into the nematic liquid crystal host. In the specific examples, the liquid crystal host was E7 (Synthon), but other compositions may be used. The concentration of the reactive mesogen was 30 wt. %, but a range of concentrations can be used provided that the nematic liquid crystal director can be reoriented in the presence of an electric field.

The polymerizable liquid crystal mixture for the example described herein was prepared by capillary filling (in the isotropic liquid phase) the mixture between the first and second substrates forming a liquid crystal cell. The first and second substrates were coated with an electrode (e.g., transparent conductive oxide Indium Tin Oxide (ITO)) and an alignment layer (e.g., rubbed polyimide). After cooling to room temperature, the liquid crystal device was mounted onto a translation stage stack in a direct laser writing system and connected to a waveform generator so that an electric field could be applied to the device during fabrication of polymer structures within the device.

To inscribe the polymer structures directly within the liquid crystal device 100, a direct laser writing system (DLW) was used. The DLW system comprised a spatial light modulator, which can correct for the spherical aberrations arising due to the mismatch in the refractive indices between the first and second substrates and the surrounding air. By writing into the liquid crystal device 100 directly, the specific orientation of the liquid crystal molecules (described by a unit vector known as the director) at the precise moment of exposure to the laser beam can be controlled. This in turn provides access to a wider range of director profiles that can be retained, or locked in, by the DLW process than would otherwise be possible if the director profile was governed solely by the alignment layers at the substrate surfaces.

The direct laser writing (DLW) process utilised femtosecond laser pulses of duration 100 fs from a Spectra-Physics Mai-Tai titanium-sapphire oscillator emitting at 790 nm, with a repetition rate of 80 MHz. The laser pulses are focused with a 0.3 NA objective lens into the liquid crystal composition. The optical power of the laser used in the examples described herein was 24 mW. A Hamamatsu X10468-02 phase-only spatial light modulator was imaged onto the pupil plane of the objective lens to correct for spherical aberration. Liquid crystal devices 100 are mounted onto a stack of high-resolution translation stages that allowed the sample to be moved relative to the laser focus with nanometre precision. A red LED was used to provide illumination so that the fabrication could be monitored in-situ with a monochrome CCD. Using the DLW system and process outlined above, polymer pillars were fabricated using a 60 ms exposure to the laser beam, while polymer walls were fabricated by moving the liquid crystal device 100 under continuous exposure to the laser beam.

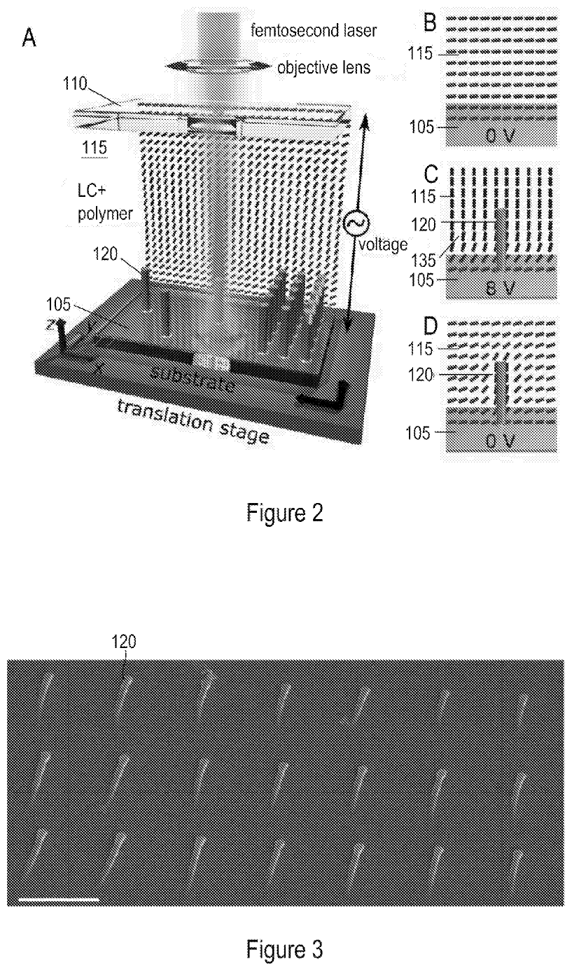

FIG. 2A shows an illustration of the DLW system used to fabricate polymer structures 120 in a liquid crystal device 100. During fabrication, the liquid crystal composition 115 located between the substrates 105, 110 of the liquid crystal device 100 is exposed to bursts of tightly focused ultrashort laser pulses. In the absence of an applied voltage, the liquid crystal molecules in the liquid crystal composition 115 assume a planar alignment (illustrated by the results from a simulation of the director profile 130 shown in FIG. 2B). When the ultrashort laser pulses are incident on the liquid crystal device 100, two-photon absorption by the photo-initiator triggers cross-linking of the reactive mesogen, resulting in the creation of a pillar structure of dense polymer network. The polymerised region 120 (i.e. the dense polymer network) retains, or locks in, the voltage dependent liquid crystal director profile 135 (i.e., the voltage dependent liquid crystal molecular orientation) at the moment of exposure to the laser beam (illustrated by the results from a simulation of the director profile 135 when a polymer pillar 120 is written at an applied voltage of V_{W}=8 V, shown in FIG. 2C). This voltage-driven liquid crystal director profile 135 plays an important role, as it defines the alignment of the liquid crystal molecules at the surfaces of the polymer pillar 120, irrespective of the voltage that is applied after fabrication.

Due to the non-linear nature of the two-photon polymerisation process, the retained, or locked in, director profile 135 is confined solely to the regions of the developed polymer, i.e., the alignment of the director within and at the surface of the polymer pillars 120 is fixed. The unpolymerised surrounding bulk material remains free to realign in the presence of an applied electric field post-fabrication. This is illustrated by the results from a simulation of the director profile 135 shown in FIG. 2D, which shows the resultant director field (i.e., the director profiles 135 of multiple liquid crystal molecules) when the device subsequently relaxes back to its equilibrium ground state upon removal of the applied voltage.

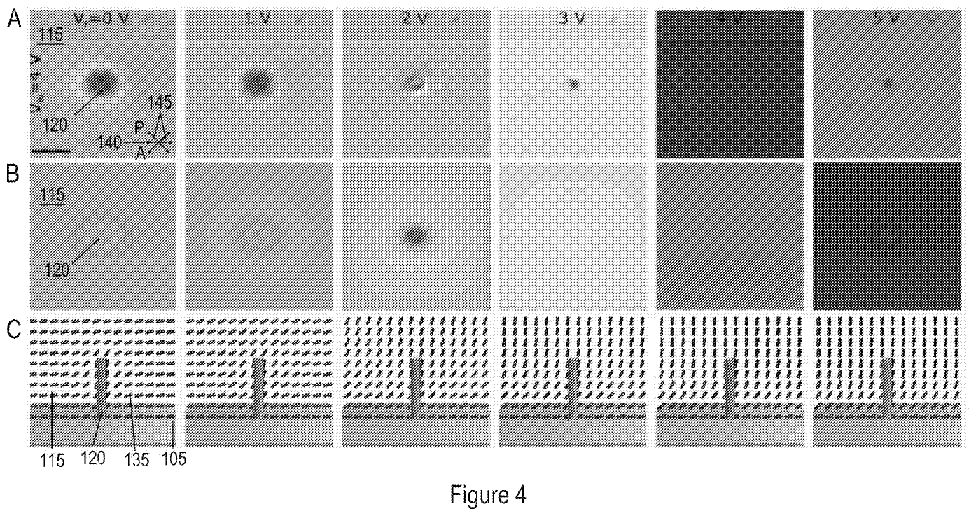

Different liquid crystal alignments can be retained, or locked in, by electrically switching the liquid crystal device 100 to different voltage amplitudes during the DLW procedure. The polymer pillars 120 written using the DLW system are shown in the Scanning Electron Micrograph in FIG. 3. The scale bar shown in the image is 40 μm. The image shown in FIG. 3 reveals that the individual pillar dimensions (approx. 1 μm in diameter and approx. 5 μm in height) are in accordance with the voxel size created by the focusing of the ultrashort laser pulses. Because the polymer pillars 120 preserve the director profile 135 of the liquid crystal molecules at the point of fabrication, they are not only birefringent in the absence of an applied voltage, but they also influence the alignment of neighbouring liquid crystal molecules in surrounding unpolymerised regions (as indicated by the results from a simulation of the director profile 135 in FIGS. 2A, 2B and 2C).

The liquid crystal devices 100 were prepared for imaging using a scanning electron microscope using the following process. The liquid crystal devices 100 were immersed in a bath of acetone for 24 hours in order to remove any unreacted (i.e., unpolymerised) liquid crystal material. The substrates 105, 110 and superstrate were then disassembled, and coated in a 27.5 nm-thick gold layer for scanning electron microscope image using a secondary electron detector. A 20 kV electron beam voltage was used at a working distance of 11.5 mm.

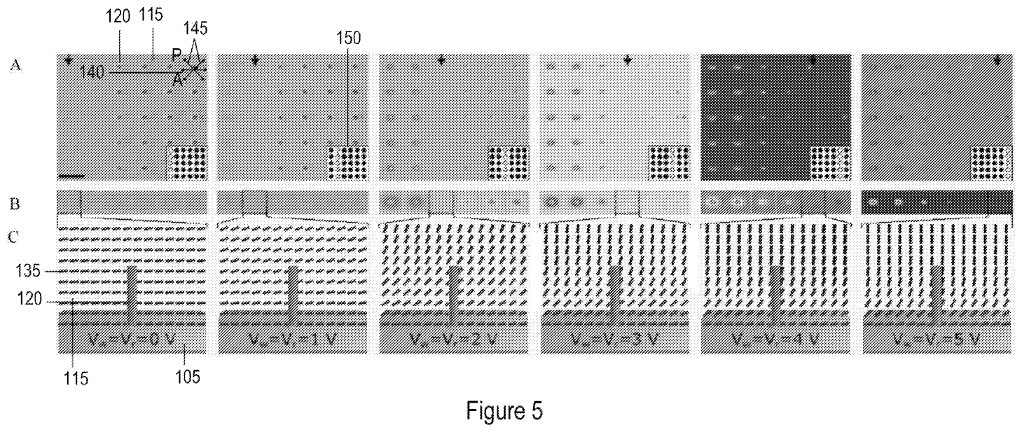

FIG. 4 demonstrates optically cloaking a polymer pillar 120 under specific voltage conditions, showing the experimental and simulation results for a single polymer pillar 120 written at a voltage of V_{W}=4 V and subsequently read at six different applied voltages after fabrication (V_{R}=0 V to 5 V, in increments of 1 V). FIG. 4A shows optical polarised microscopy (OPM) images of the single polymer pillar 120, FIG. 4B shows equivalent simulated OPM images to those shown in FIG. 4A, while FIG. 4C shows simulated director profiles 135 for the single polymer pillar 120. The arrow 140 indicates the orientation of the optic axis of the nematic phase on the left-most image of FIG. 4A, while the arrows 145 indicate the orientation of the crossed polarisers on the left-most image of FIG. 4A. The scale bar shown in the left-most image of the OPM images is 10 μm.

An Olympus BX51 optical polarising microscope was used to obtain images of the polymer structures 120 between crossed polarisers, and also for unpolarised light. An orange longpass filter was inserted into the optical path below the sample to ensure the microscope bulb did not cause further polymerisation of any of the remaining uncured reactive mesogens in the liquid crystal composition. The liquid crystal director (optic axis) was oriented at 45° to the polariser, and was analysed by rotating the liquid crystal device 100 until the bright state was found.

As can be seen in FIG. 4A, at applied voltages for which the condition V_{R}≠V_{W} holds (in this case all voltages except V_{R}=4 V), the polymer structure 120 is clearly visible against the background liquid crystal phase when viewed on an optical microscope. This is because, at these voltages, the birefringence of the polymer pillar 120 is different from the surrounding regions of liquid crystal, which in turn leads to differences in the phase of light transmitted through the device. The polymer structure is thus distinguishable against the liquid crystal background. Conversely, when the read voltage, V_{R}, applied to the device matches the write voltage, V_{W} (in this case V_{R}=V_{W}=4V), the director field in the regions surrounding the pillar 120 and within the pillars 120 themselves merge almost seamlessly into the background, thereby resulting in the pillar 120 being hidden. It should be noted that the contrast between the polymer pillar 120 and the unpolymerised liquid crystal is more significant at low voltages because the elastic distortion around the polymer pillar 120 becomes pronounced at values of V_{R}<4 V, where the predominantly planar liquid crystal alignment in the bulk is more distinct relative to the hybrid alignment retained, or locked in, at the surface of the polymer pillar 120.

The experimental results (shown in FIG. 4A) are found to be in good agreement with the simulated OPM images of a polymer pillar 120 in a nematic liquid crystal that is subjected to planar alignment layers on the substrate surfaces (shown in FIG. 4B), and confirm the idea of optically cloaking a polymer structure 120 in a polymerisable liquid crystal device 100.

The simulated OPM images were obtained from the calculation of the director profiles 135 (shown in FIG. 4C) using the 2×2 Jones matrix. The simulation of the nematic liquid crystal ordering in the planar aligned cell containing the polymer pillar 120 relies upon a continuum model that uses the Landau-de Gennes free energy minimisation approach. A tensor order parameter Qᵢⱼ describes the orientational order of the liquid crystal molecules, while the tensorial invariants of Qᵢⱼ constitute the total free energy, including both the bulk and surface free energies to account for the anchoring on both the glass cell surfaces and the polymer pillar/bulk liquid crystal interface. The free energy was minimised numerically using an explicit Euler relaxation finite difference scheme. Numerical simulations were performed in two consecutive stages in order to mimic the DLW process of retaining, or locking in, spatially dependent director fields and creating arbitrarily complex anchoring within the bulk of the liquid crystal device 100. First, the director profile 135 was calculated in a planar aligned nematic cell without the presence of the polymer structure 120 and an applied voltage. The director profile 135 was then simulated for different voltages and these profiles 135 were used to define the anchoring on the polymer pillars 120 that were fabricated using DLW, which is assumed to be strong and spatially dependent.

The simulated OPM images shown in FIG. 4B, in accordance with the experimental results, reveal a clear mismatch between the birefringence of the polymer pillar 120 and the surrounding bulk liquid crystal when V_{R}≠V_{W}, as light of different colours is transmitted through the distorted region around the pillar 120. As the value of V_{R} increases however, the distortion around the pillar 120 structures decreases significantly until V_{R}=V_{W}=4 V, wherein the polymer structure 120 can no longer be differentiated from the surrounding bulk liquid crystal. The polymer structure 120 therefore appears to vanish (in agreement with the experimental results shown in FIG. 4A). The corresponding director profile 135 simulations shown in FIG. 4C show that when the polymer pillar 120 is formed at a fabrication voltage of V_{W}=4 V, the liquid crystal director profile 135 assumes a tilted orientation in the direction of the applied electric field in the bulk, but is more planar aligned near the substrates 105, 110 (due to the boundary conditions imposed by the rubbed alignment layers). Furthermore, it is clear that the director profile 135 only becomes continuous when the read voltage V_{R} is equivalent to the write voltage V_{W}, which leads to a uniform birefringence across the liquid crystal device 100.

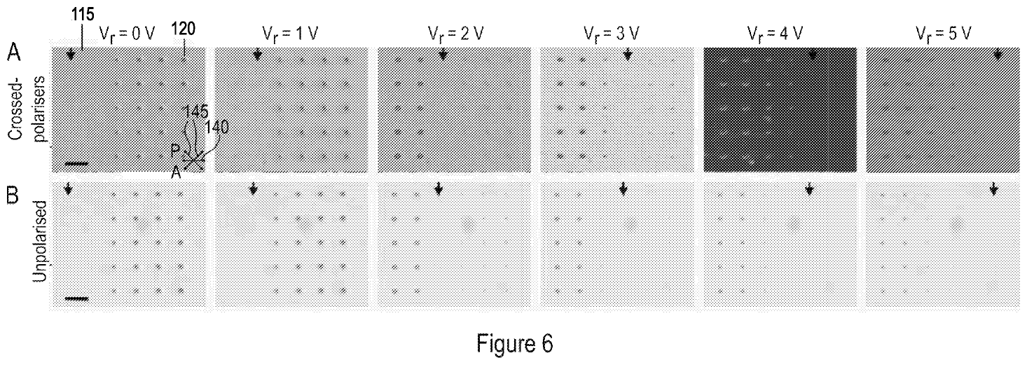

Since it is possible to lock-in different alignments with different voltage amplitudes, individual polymer pillars 120 in an array of polymer pillars 120 can be hidden at different read voltages V_{R}. This effect is shown in FIG. 5. OPM images of a 5×6 array of polymer pillars 120 with a lattice spacing of 40 μm that are imaged under the same read voltage conditions (V_{R}=0 V to 5 V, in increments of 1 V) are presented in FIG. 5A. Each column of polymer pillars 120 in the array, excluding the first column on the left hand side of the array (which was written in the ground state V_{W}=0 V), was fabricated under the application a 1 kHz square wave with increasing voltage amplitude from V_{W}=1 V to 5 V in increments of 1 V (viewed from left to right in the array). Columns of polymer pillars 120 with equivalent write voltages and read voltages are indicated by the arrows located above the respective columns. Under these conditions (V_{R}=V_{W}), the birefringence in the bulk liquid crystal matches the surface conditions on the polymer pillars 120, resulting in polymer structures 120 that appear to be hidden as the director profile 135 is substantially continuous. The insets 150 in the OPM images of FIG. 5A illustrate which column in the array has been rendered invisible for that specific read voltage. The arrow 140 indicates the orientation of the optic axis of the nematic phase on the left-most image of FIG. 5A, while the arrows 145 indicate the orientation of the crossed polarisers on the left-most image of FIG. 5A

Simulated OPM images, and simulated director fields, for the experimental conditions described above with respect to FIG. 5A are shown in FIG. 5B and FIG. 5C respectively. The simulated OPM images in FIG. 5B corroborate that the polymer pillars 120 in each column disappear when the V_{R}=V_{W} condition is satisfied. In each case, the surrounding director field matches the director profile 135 that is imposed by the anchoring at the surface of the polymer pillars 120, which can be clearly seen in the simulation results presented in FIG. 5C. It is worth noting, however, that the polymer pillars 120 are slightly more distinguishable for the V_{R}=V_{W}=1 V case as this value is approximately of the same order as the Fréedericksz threshold voltage (V_{TH}) of the liquid crystal device 100, estimated to be approximately 0.9 V based on the host liquid crystal material parameters. The visibility of the polymer pillars 120 is restored when the voltage is adjusted such that V_{R}≠V_{W} condition is satisfied. The elastic distortion surrounding the polymer pillars 120 is more pronounced for large write voltages (V_{W}≥3 V) when V_{R}<V_{W}, due to the transition in the bulk director profile 135 from planar to homeotropic at larger applied voltages, making the polymer pillars 120 more visible when V_{R}≠V_{W}.

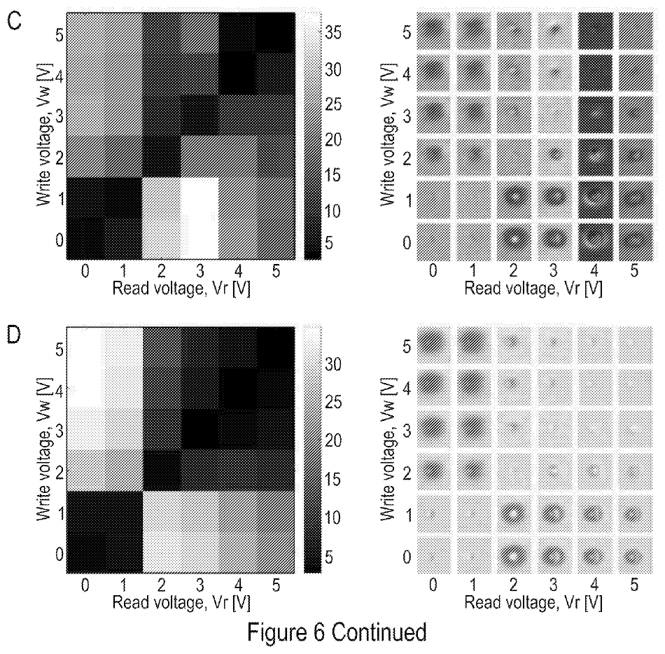

FIG. 6 demonstrates optical cloaking in a polymer pillar array at read voltages of V_{R}=0 V to 5 V (in increments of 1 V) for both polarised light (see the OPM images in FIG. 6A), using crossed polarisers (the arrow 140 indicates the orientation of the optic axis of the nematic phase in the left-most image of FIG. 6, while the arrows 145 indicate the orientation of the crossed polarisers in the left-most image of FIG. 6), and unpolarised light (see the images in FIG. 6B). The array of polymer pillars 120 of FIG. 6 has the same design as that shown in FIG. 5, with each column of polymer pillars 120 from left to right written at write voltages of V_{W}=0 V to 5V (in increments of 1 V).

Image analysis was performed to quantify the visibility of the polymer pillars 120 for both crossed polarisers (FIG. 6C) and unpolarised light (FIG. 6D), and shows that optical cloaking occurs when V_{W}=V_{R}. Image analysis was performed in MATLAB by firstly cropping an image of each pillar 120 at each read voltage. The cropped images were then placed in a matrix according to their read write voltage. These images of individual polymer pillars 120 were then converted from RGB to grayscale, before finding the standard deviation of each image to quantify the degree of visibility. The standard deviation data was converted to a matrix and plotted in each of FIGS. 6C and 6D with a grayscale colourmap. Low values of standard deviation are black and high values of standard deviation are white. A minimum in visibility is seen along the diagonal line where V_{W}=V_{R}. Furthermore, FIGS. 6C and 6D show the significant impact of the Fréedericksz threshold (V_{TH}≈0.9 V) on the visibility of the polymer pillars. This is especially apparent for unpolarised light where the pillars 120 written above the threshold voltage (V_{W}>V_{TH}) all have a similar visibility when the read voltage is also above this threshold voltage (V_{R}>V_{TH}), and vice versa for polymer pillars 120 with write voltages below the threshold voltage (V_{W}<V_{TH}).

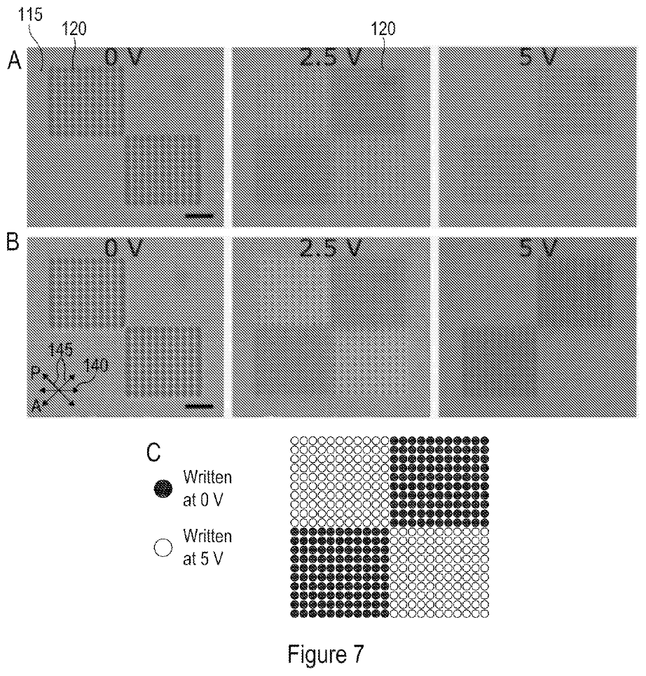

By tailoring the write and read voltages, it is possible to make polymer structures 120 in a liquid crystal device 100 appear and disappear in the surrounding liquid crystal host. Moreover, by exploiting the ability to render objects visible or invisible, it is possible to reconfigure the polymer structures 120 so that different features of patterns emerge at different voltage amplitudes. FIGS. 7 to 10 illustrate this capability in more detail.

FIG. 7 shows a polymer pillar array divided into four quadrants to form a checkerboard pattern. The polymer pillars 120 contained in the upper-left and lower-right quadrants of the array are written at V_{W}=5 V, while the polymer pillars 120 contained in the upper-right and lower-left quadrants are written at V_{W}=0 V. FIG. 7A shows a series of images at different read voltages (from left to right: V_{R}=0 V; V_{R}=2.5 V; V_{R}=5 V) of the polymer pillar array using unpolarised light, while FIG. 7B shows a series of images at different read voltages (from left to right: V_{R}=0 V; V_{R}=2.5 V; V_{R}=5 V) using polarised light—the arrow 140 indicates the orientation of the optic axis of the nematic phase, while the arrows 145 indicate the orientation of the crossed polarisers. The scale bar on the images at V_{R}=0 V is 40 μm. FIG. 7C is a schematic of the polymer pillar array indicating which polymer pillars 120 are written at V_{W}=0 V and V_{W}=5 V respectively.

As can be seen from the images in FIGS. 7A and 7B for a read voltage of V_{R}=0 V, the polymer pillars 120 written at V_{W}=0 V are invisible, whereas the polymer pillars 120 written at V_{W}=5 V are easily visible. At a read voltage of V_{R}=2.5 V, both the polymer pillars 120 written at V_{W}=0 V and the polymer pillars 120 written at V_{W}=5 V are visible. At a read voltage of V_{R}=5 V, the polymer pillars 120 written at V_{W}=5 V disappear and are invisible, while the polymer pillars 120 written at V_{W}=0 V are clearly visible. This example demonstrates that polymer structures 120 written at different write voltages can be made to selectively appear and disappear at different read voltages, with the polymer structures 120 becoming invisible when V_{W}=V_{R}.

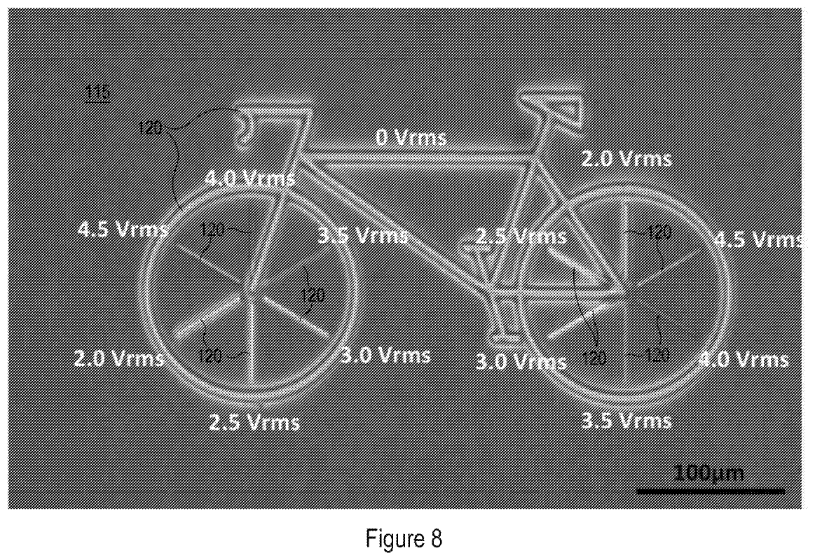

FIG. 8 shows an image of a “micro-bicycle” polymer structure 120 written into a liquid crystal device 100. The spokes of the wheels of the micro-bicycle are written at different write voltages ranging from V_{W}=2 V to 4.5 V, in increments of 0.5 V. The frame of the micro-bicycle is written at V_{W}=0 V. The scale bar of the image of FIG. 8 is 100 μm. This is an extension of the principle of retaining or locking in different liquid crystal director profiles 135 in polymer structures 120. Varying birefringences are produced by the different locked in liquid crystal director profiles 135, which results in a vivid array of colours produced by the polymer structures 120.

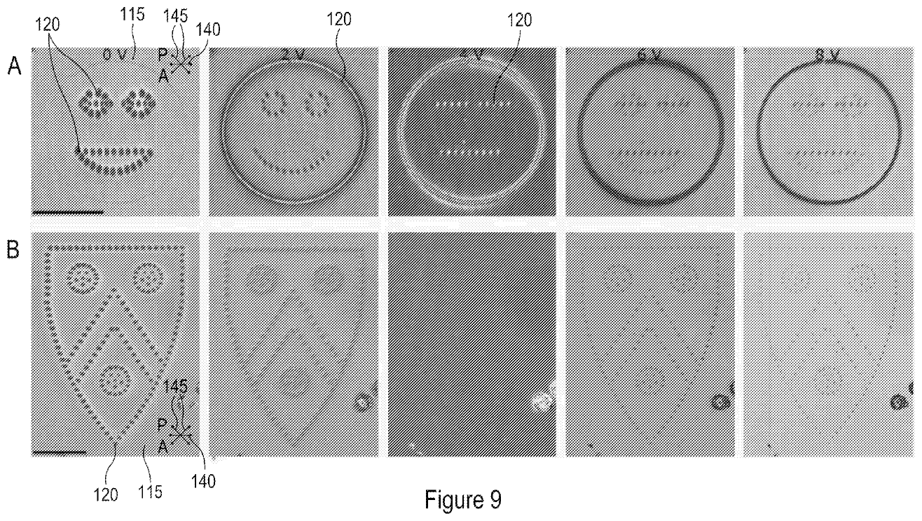

FIG. 9 shows a selection of OPM images of different designs at a number of different read voltages. FIG. 9A shows OPM images of a reconfigurable emoticon with different features of the emoticon written at different write voltages. The arrow 140 indicates the orientation of the optic axis of the nematic phase, while the arrows 145 indicate the orientation of the crossed polarisers. The scale bar of the image at V_{R}=0 V is 100 μm. As displayed by the reconfigurable emoticon of FIG. 9A, it is possible to make particular polymer structures selectively appear and disappear at different read voltages. In this case, changes in the facial expression of the emoticon are seen at different read voltages. The outline of the eyes and mouth are polymer pillars 120 written at a write voltage of V_{W}=4 V, while the outline of the emoticon is a polymer wall 120 written at a write voltage of V_{W}=0 V. The outline and centre of the eyes of the emoticon, and the upper and lower parts of the mouth of the emoticon are all visible at V_{R}=0 V. However, at V_{R}=2 V, the polymer pillars 120 defining the centre of the eyes and the upper part of the mouth both become invisible, while the circle outlining the edge of the emoticon becomes visible. At V_{R}=4 V, the centre of the eyes and the upper part of the mouth become visible again, while the lower part of the mouth and the outline of the eyes become invisible. The circle outlining the edge becomes more strongly visible. At V_{R}=6 V and V_{R}=8 V, all of the features of the emoticon are visible, although the facial features are less strongly visible than the circle outlining the edge. This is because the difference between V_{W} and V_{R} is not as large for the facial features as for the circle outlining the edge of the emoticon, which results in a smaller mismatch between the locked in liquid crystal director profile 135 and the liquid crystal director profile 135 of the surrounding bulk liquid crystal composition. By encoding different polymer features 120 into the liquid crystal device 100 at different write voltages, and then tuning to read voltage accordingly, it is possible to reconfigure the emoticon to display a different emotion. This capability can be extending generally to reconfigure a liquid crystal device 100 to selectively display all, some or none of the polymer structures 120 contained within the liquid crystal device 100, depending on the strength of the electric field applied to the liquid crystal device 100.

FIG. 9B shows OPM images of an arrangement of polymer pillars 120 resembling the New College Crest, Oxford University. The arrow 140 indicates the orientation of the optic axis of the nematic, while the arrows 145 indicate the orientation of the crossed. All the features of the Crest are written at V_{W}=4 V. As such, all of the features are visible at read voltages where V_{R}≠V_{W}, with the Crest becoming completely invisible at a read voltage of V_{R}=4 V. The scale bar shown on the V_{R}=0 V image is 100 μm.

As can be seen from the images of the liquid crystal devices 100 shown in FIGS. 4 to 7 and FIG. 9, when the read voltage is equal to the write voltage of the polymer structures 120 (i.e. V_{R}=V_{W}), the polymer structures 120 become optically invisible (under both polarised and unpolarised light). Furthermore, the polymer structures 120 are invisible relative to all of the liquid crystal material in the liquid crystal device 100.

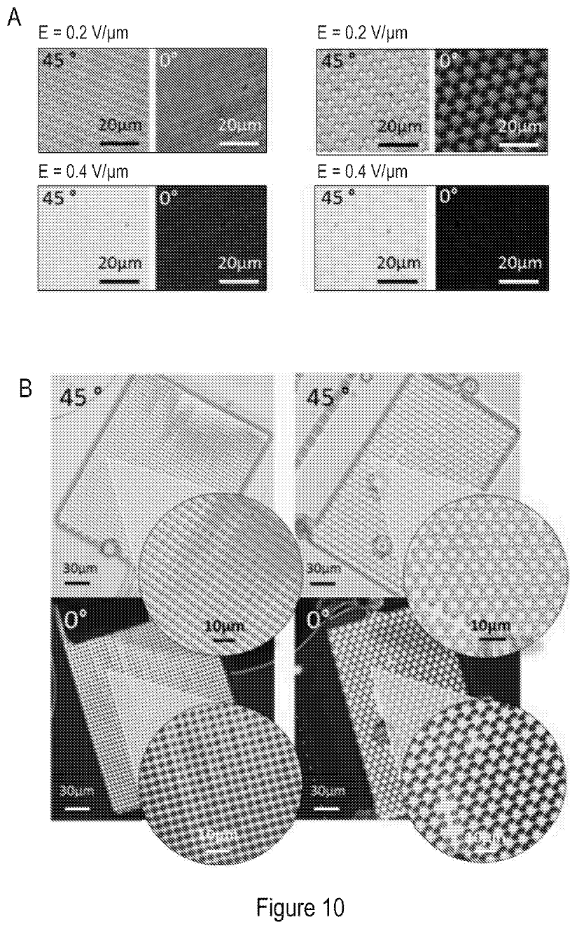

This particular feature is highlighted by the images shown in FIG. 10. FIGS. 10A and 10B show OPM images from Tartan et al of square and hexagonal polymer pillar arrays in a liquid crystal device with substrates rubbed in parallel directions (as opposed to the anti-parallel rubbing directions of the substrates of the liquid crystal devices described herein). The polymer pillars were fabricated in situ under the application of a 0.4 V μm⁻¹ electric field, with the molecules aligned in a bend configuration. As can be seen from the images in FIG. 10A, when the read voltage is equal to the write voltage (i.e. V_{R}=V_{W}), the polymer pillars become substantially optically invisible relative to the nearby surrounding liquid crystal material, for both the square and hexagonal polymer pillar arrays. However, FIG. 10B shows that although the polymer pillars become substantially optically invisible relative to the surrounding liquid crystal material confined to an area bounded by the polymer pillar array, the polymer pillars are not optically invisible relative to surrounding liquid crystal composition in the liquid crystal device outside of the area bounded by the polymer pillar array, as in the examples described herein. The region of optical invisibility is confined to the area bounded by the polymer pillar array. This feature is exhibited, and shown distinctly in FIG. 10B, as a difference in background colour (i.e., a difference in birefringence) between the surrounding liquid crystal composition bounded by the polymer pillar arrays, and the surrounding liquid crystal composition not bounded by the polymer pillar arrays (i.e., the liquid crystal composition throughout the rest of the liquid crystal device).

It is therefore clear that anti-parallel rubbing directions of the substrates 105, 110 of the liquid crystal device 100 of the examples described herein produces improved optical invisibility (i.e., optical invisibility of polymer structures 120 relative to the liquid crystal composition 115 and not limited to the area bounded by polymer structures 130 contained within a liquid crystal device 100) when compared to the parallel rubbing directions of the substrates of the liquid crystal device of the prior art (which produces optical invisibility of polymer structures only relative to liquid crystal composition contained in the area bounded by the polymer structures). By utilising anti-parallel rubbing directions on the substrates 105, 110 of a liquid crystal device 100, neither the polymer structures 120 nor the regions of a liquid crystal device 100 containing the polymer structures 120 can be identified (i.e., are optically visible) when V_{R}=V_{W}.

Potential uses of both the liquid crystal devices 100 described herein (with anti-parallel rubbing directions on the first substrate 105 and the second substrate 110) and the liquid crystal devices of Tartan et al (with parallel rubbing directions on the first substrate and the second substrate) include security applications, for example as a covert security marking to be placed on products for authentication purposes. Such security markings could be used, for example, to verify the authenticity of the manufacturer of a product. The display output by the liquid crystal device 100 (being used a security marking) in response to the application of an electric field could be compared with a verification code associated with a product. If the display output by the liquid crystal device 100 matches the verification code associated with the product, then the authenticity (or origin) of the product may be verified.

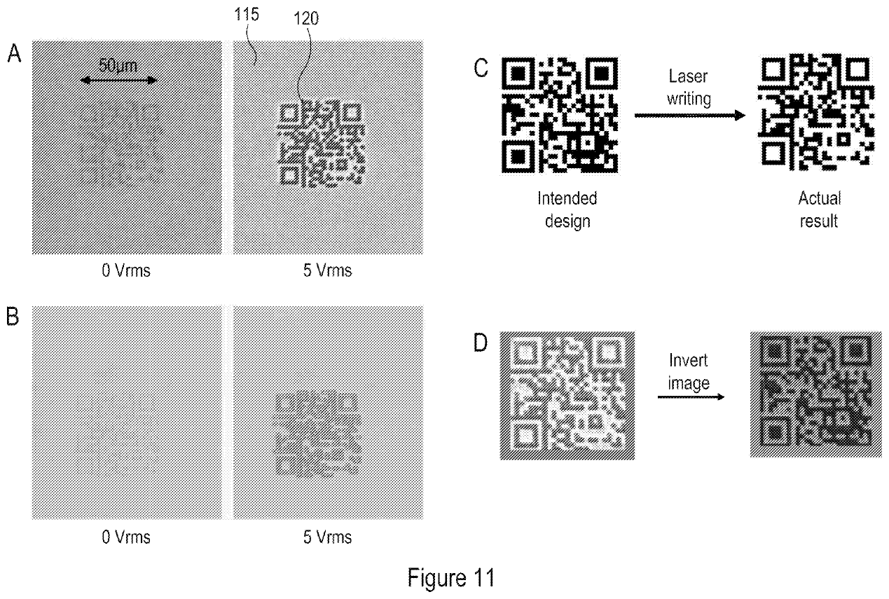

FIGS. 11A and 11B show images of a liquid crystal device 100 (with anti-parallel rubbing directions on the first substrate 105 and the second substrate 110) in which polymer structures 120 are fabricated in the form of a verification code, in this case a QR (Quick Response) code. Any image, code or pattern could be used as a verification code in place of a QR code. FIG. 11A shows OPM images, while images shown using unpolarised light are shown in FIG. 11B. The spacing of the polymer pillars 120 in both FIGS. 11A and 11B is 2 μm. The overall width of the QR code is approximately 50 μm. The pixels of the QR code (i.e., the polymer pillars 120) were written at V_{W}=0 V. As expected, the polymer structures 120 of the QR code are substantially optically invisible at V_{R}=0 V, becoming more visible as the read voltage is increased. Images in FIGS. 11A and 11B show the visibility of the QR code under the application of a read voltage of V_{R}=5 V for both polarised and unpolarised light. In this case (i.e., for polymer structures 120 written at V_{W}=0 V), a liquid crystal device 100 can be configured to display a verification image, pattern or code only under the application of an electric field. Once displayed, the verification code can be verified to authenticate, for example, the manufacturer of a product.

The example shown in FIGS. 11A and 11B demonstrates that a verification code written in a liquid crystal device 100 at V_{W}=0 V will be optically invisible under a read voltage of V_{R}=0 V, but will become visible when an electric field is applied to the liquid crystal device 100. In this way, a reconfigurable verification code can be produced. The information regarding the verification code is permanently stored within the liquid crystal device 100, but is only visible upon the application of a particular electric field.

Alternatively, a “corrupted” verification code could be produced in a liquid crystal device 100 by writing the polymer structures 120 that make up the verification code at one non-zero write voltage (e.g. V_{W}=2 V), whilst also writing additional polymer structures 120 that are not part of the verification code at another, different, non-zero write voltage (e.g. V_{W}=4 V). In this way, under read voltage conditions of 0 V (e.g., during transport of the product, or during normal intended use of the product), the polymer structures 120 of the verification code would be visible, but only alongside additional polymer structures 120 not forming part of the verification code. If an attempt was made to verify the verification code at a read voltage of V_{R}=0 V, it would not be successful. However, if a read voltage corresponding to the write voltage of the additional polymer structures 120 not forming part of the verification code were to be applied to the liquid crystal device 100 before attempting to verify the verification code, the additional polymer structures 120 would become optically invisible, leaving only the polymer structures 120 making up the verification code visible. In this way, the verification code would only be able to be verified at the correct read voltage—the verification code itself would always be visible, but would only be verifiable when the additional polymer structures 120 become optically invisible and disappear at the correct read voltage.

A liquid crystal device 100 with polymer structures 120 written at a plurality of write voltages could also be used to display a series of separate and distinct verification codes, by applying a series of read voltages configured to make at least some of the polymer structures 120 disappear (become optically invisible). In the manner described above with respect to “corrupted” verification codes, the additional polymer features 120 could themselves make up a separate, distinct verification codes verifiable only at certain read voltages. Any number N of verification codes (each comprising one or more polymer structures 120) could be written at an equivalent number N of distinct write voltages. Each of the N verification codes could be made optically visible by the application of an electric field which causes at least some of the polymer structures 120 to disappear (i.e. when V_{R}=V_{W}). As such, a series of electric fields could be applied to the liquid crystal device 100 to selectively cause some of the polymer structures 120 to disappear on the application of each of the electric fields. In this way, a series of reconfigurable verification codes can be produced. The electric fields (read voltages V_{R}) need not be applied in order of increasing amplitude, i.e., the series of verification codes need not be displayed in order of increasing amplitude of the applied electric field at which certain polymer structures 120 disappear. The series of verification codes displayed by the liquid crystal device 100 could be compared to a series of verification codes associated with a product. If the series of verification codes displayed by the liquid crystal device 100 matches the series of verification codes associated with the product (preferably, but not necessarily, with the series in the same order), then, for example, a product comprising the liquid crystal device can be authenticated.

The verification codes could be used to authenticate a product by, for example, utilising the following protocol (or a similar protocol) to verify the manufacturer of a product. A manufacturer could provide a particular verification code (e.g., an image, pattern or code) associated with a particular product that is manufactured by the manufacturer. The verification code could then be written into a security marking comprising a liquid crystal device 100 by forming polymer structures 120 in the liquid crystal device 100 at a suitable write voltage, depending on how the verification code is to be utilised (i.e., either an invisible verification code comprising polymer structures 120 written at V_{W}=0 V which only appears under the application of an electric field, or a visible verification code comprising polymer structures 120 written under the application of an electric field which can only be verified when other polymer structures 120 written under the application of an electric field of a different strength selectively disappear under the application of the corresponding read voltage). The security marking comprising the liquid crystal device 100 could then be provided within (e.g., embedded in) or located on the product. The manufacturer could then provide the verification code to a third party (e.g., a user or distributor of the product with which the verification code is associated), together with the electric field conditions under which the verification code will become visible. The third party could then check the authenticity of the products with which it is supplied by applying the correct electric field to the security marking comprising the liquid crystal device 100 comprising the verification code, and comparing the displayed verification code with the verification code supplied by the manufacturer. If the display output by the liquid crystal device 100 matches the verification code provided by the manufacturer, then the authenticity of the manufacturer of the product may be verified, and the product may be authenticated.

Alternatively, the verification code could be used more simply for authentication purposes. The liquid crystal device 100 could be configured to display nothing (i.e., no image, code or pattern) with no electric field applied (i.e., polymer structures written at V_{W}=0 V). However, if there is any change in what is displayed by the liquid crystal device 100 under the application of an electric field (i.e., polymer structures 120 written at V_{W}=0 V become visible), then the product may be determined to be authentic. Likewise, the liquid crystal device 100 could be configured to display something (i.e., an image, code or pattern) with no electric field applied (i.e., polymer structures 120 written at V_{W}>0 V). However, if there is any change in what is displayed by the liquid crystal device 100 under the application of an electric field (i.e., all or some of the polymer structures 120 written at V_{W}>0 V become invisible), then the product may be determined to be authentic.

In the images shown in FIGS. 11A and 11B, the QR code is produced by polymer structures 120 appearing darker than the liquid crystal background under the application of an electric field. The QR code displayed in FIGS. 11A and 11B is actually an inversion of the intended QR code design shown in FIG. 11C. This could easily be changed by inverting the design before fabrication, i.e. by writing the dark pixels of the intended QR code design using the DLW system, rather than by writing the white pixels of the intended QR code design using the DLW system as shown in FIGS. 11A and 11B. Alternatively, the image produced by the QR code under the application of an electric field could be inverted before verification (as shown in FIG. 11D). In some cases, a border of the same colour as the pixels of the QR code may need to be placed around the QR code to make it readable (as shown in the left hand image of FIG. 11D). This can be achieved via image processing after the QR code is displayed under the application of an electric field.

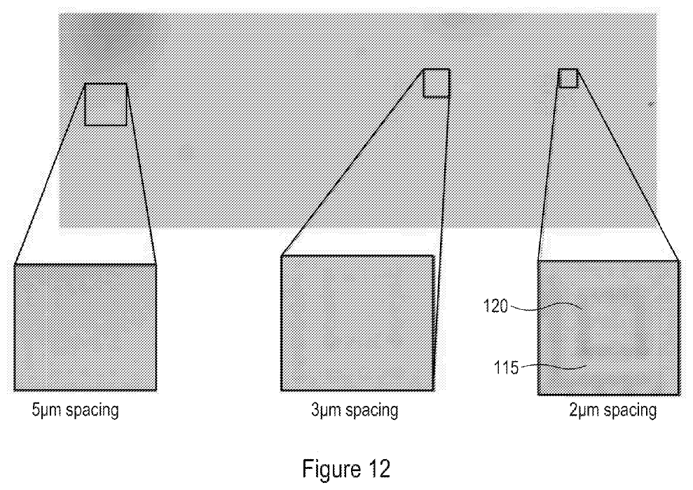

FIG. 12 shows an image, under unpolarised light, of the same QR code written at a variety of polymer pillar spacings, with parts of the image expanded to accentuate differences in visibility. A QR code was written in three separate locations in a liquid crystal device 100, with pillar spacings of 2 μm, 3 μm and 5 μm respectively. In all cases, the polymer pillars 120 were written at V_{W}=0 V. Both FIG. 12 and the expanded regions of FIG. 12 show that as the spacing between the polymer pillars 120 decreases, the optical visibility of the polymer pillars 120 increases (even in the case, as shown in FIG. 12, of V_{R}=V_{W}). The reason for this may be that the fixed liquid crystal director profile 135 within and at the surface of the polymer pillars 120 elastically distorts the liquid crystal director profile 135 of the liquid crystal composition 115 surrounding the polymer pillars 120, even when the polymer pillars 120 are written at V_{W}=0 V. This elastic distortion is minimised when V_{R}=V_{W}, such that the director profile 135 within and at the surface of the polymer pillars 120 and the director profile 135 of the surrounding liquid crystal composition 115 is substantially identical. As such, the birefringence of the polymer pillars 120 and the surrounding liquid crystal composition 115 is also substantially identical, rendering the polymer pillars 120 optically invisible. However, when the spacing between the polymer pillars 120 is reduced, the polymer pillars 120 no longer effectively behave as separate, non-interacting polymer structures 120. Instead, the director profile 135 in the surrounding liquid crystal composition 115 is elastically distorted by each of the polymer structures 120 which it surrounds. The director profile 135 deformation induced by the polymer structures 120 therefore becomes amplified in the intermediate space between the polymer structures 120, leading to slight differences in birefringence between the polymer structures 120 and the surrounding liquid crystal composition 115, even when V_{R}=V_{W}. The slight difference in birefringence between the polymer structures 120 and the surrounding liquid crystal composition 115 when the spacing between the polymer structures 120 is reduced, even at V_{R}=V_{W}, leads to the increased visibility of the polymer structures 120 at V_{R}=V_{W} as the polymer structure spacing is reduced. However, the increase in optical visibility with reduced polymer structure spacing (i.e., down to 2 μm spacing) is not large enough that the QR code can be recognised by a reader. The increase in optical visibility is merely large enough that the human eye recognises a slight difference between the polymer structures 120 and the background liquid crystal composition 115.

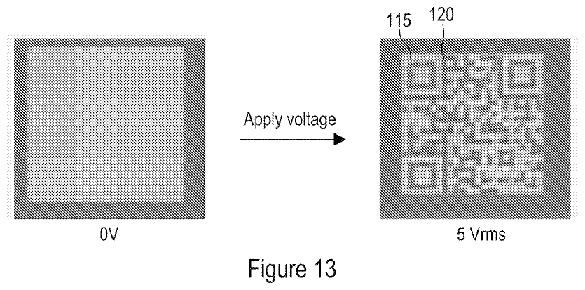

The improved optical invisibility with even slightly increased spacing between polymer structures 120 is shown in FIG. 13. FIG. 13 shows an image of the same QR code as that shown in FIGS. 11 and 12, with the polymer structures 120 again written at V_{W}=0 V. The image was taken using unpolarised light at 10× magnification. The spacing between the polymer pillars 120 is 3 μm. No image enhancement has been made to the image of FIG. 13 other than to place a border (of the same colour as the pixels of the QR code) around the QR code. When compared to the optical visibility of the 2 μm spacing between polymer structures 120 of FIG. 11, it can be seen that the polymer structures 120 spaced 3 μm apart are less visible at V_{R}=V_{W}=0 V. This decreases the ability of any scanner or person being able to identify the security marking or verification code without the application of an electric field. The individual polymer structures 120 are also more easily identifiable under a read voltage of V_{R}=5 V.

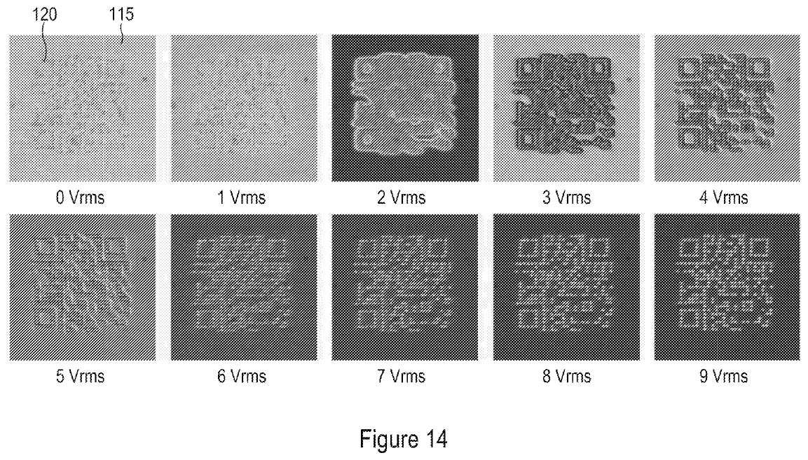

FIG. 14 shows a series of OPM images taken at 50× magnification for a QR code with a spacing of 2 μm between the polymer pillars 120. The polymer pillars 120 were written at V_{W}=0 V. As the read voltage increases from V_{R}=0 V to 9 V, in increments of 1 V, it can be seen that the individual pixels (i.e., polymer pillars 120) become more distinct as the read voltage increases. This is because at lower voltages, the nematic coherence length is longer. The polymer pillars 120 therefore have a larger radius of influence on the surrounding liquid crystal molecules at lower voltages, resulting in a higher (and therefore more visible) variation in birefringence in the liquid crystal composition 115 immediately surrounding the polymer structures.

A liquid crystal device 100 may be incorporated into or onto existing products as part of a security marking. For example, the liquid crystal device 100 may be incorporated into products simply by attaching a security marking comprising the liquid crystal device 100 to the product, for example, by using an adhesive sticker. The security marking may be embedded in the adhesive sticker itself, or may be located between the product and the adhesive sticker when in use (thereby securing the security marking to the product). At least a portion of the adhesive sticker may be transparent to enable a display output by the liquid crystal device 100 to be detected. A light source may be provided to illuminate the liquid crystal device 100 through the thickness of the liquid crystal device, although light reflected from the liquid crystal device 100 may also be detected to verify the security marking.

Alternatively, a security marking comprising a liquid crystal device 100 may be embedded directly into products. Products particularly suitable for incorporation of a security marking in this manner include, for example, windows and other glass panel structures. This is because light is able to travel through the liquid crystal device 100 of the security marking without a dedicated light source located behind (as the observer would view the liquid crystal device 100) the liquid crystal device 100 due to the transparent nature of the glass products in which the liquid crystal device is incorporated. The functioning of the liquid crystal device is therefore not diminished or removed by embedding the liquid crystal device 100 in the products. Embedding the liquid crystal device 100 in the products as part of the manufacturing process also increases the difficulty of forgery.

A further alternative option is to directly incorporate a security marking into an existing liquid crystal display (LCD) screen by writing polymer structures, for example in the form of a verification code, directly into the existing LCD screen. This may be achieved by utilising the DLW system, during manufacturing of the LCD screen, to produce polymer structures in the existing liquid crystal composition of the LCD screen pixels.

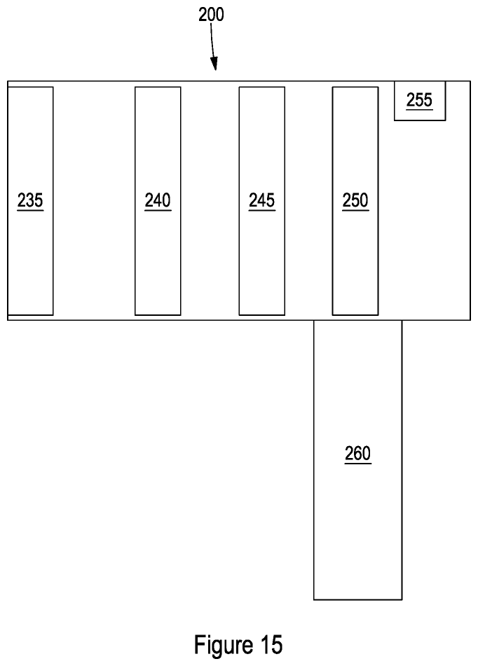

A verification code displayed by a liquid crystal device 100 may be verified by eye when compared to a verification code associated with a product. Alternatively, a reader or detector (i.e., a verification device) capable of reading or detecting the display (e.g., a verification code) produced by a liquid crystal device 100 may be used to verify the verification code of the liquid crystal device 100, and therefore authenticate the product to which the security marking is attached. FIG. 15 shows a schematic of a reader or detector 200 capable of verifying a verification code displayed by a liquid crystal device 100. The detector comprises an optical detector 235 configured to detect the display (e.g., verification code) output by a security marking comprising the liquid crystal device 100. The detector also comprises a memory 240, the memory 240 containing a verification code associated with a product, and also configured to store (temporarily or permanently) the display output by the liquid crystal device 100. The detector also comprises a processor 245, the processor 245 configured to perform a comparison between the detected display output by the liquid crystal device 100 and the verification code stored in the memory 240, and also configured to verify a detected verification code if the detected display output by the liquid crystal device 100 matches the verification code stored in the memory 240. If the security marking comprising the liquid crystal device 100 is verified, a verification signal (e.g., a light or sound indicating verification has been successful) is output by the detector 200 at a confirmation output 255.

The optical detector 235 may be a camera, a CCD, a raster-scanning laser, a photodiode detector, or any other type of detector suitable for detecting a display output by a liquid crystal device 100.

The detector 200 may also comprise a power source 250 (shown in FIG. 15) configured to supply power to a liquid crystal device 100. Power is supplied to the liquid crystal device 100 in order to apply an electric field across the liquid crystal device 100, thereby displaying a verification code to be evaluated by the detector 200. By using the detector 200 to supply power to the liquid crystal device 100, there is no need to provide the liquid crystal device 100 with a separate power supply to be incorporated into or onto a product to be marked using the liquid crystal device 100. This therefore simplifies the implementation of such a liquid crystal device 100 as a security marking.

The detector 200 may be handheld, enabling the user to manually bring the detector 200 into position to detect a display output by a liquid crystal device 100. A handle 260 may be provided on the detector 200 (as shown in FIG. 15). Alternatively, the detector may be mounted either movably or fixedly on a support. In this case, products with security markings to be verified are brought to the optical detector 235 of the detector 200 to detect a display output by a liquid crystal device 100 of the security marking.

From reading the present disclosure, other variations and modifications will be apparent to the skilled person. Such variations and modifications may involve equivalent and other features which are already known in the art of liquid crystal devices, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom.

For the sake of completeness, it is also stated that the term “comprising” does not exclude other elements or steps, the term “a” or “an” does not exclude a plurality, a single processor or other unit may fulfil the functions of several means recited in the claims and any reference signs in the claims shall not be construed as limiting the scope of the claims.

1. A method of authenticating a product, the method comprising;
receiving a verification code associated with the product;
applying an electric field to a liquid crystal device located in or on the product, the liquid crystal device comprising:
a first substrate;
a second substrate spaced apart from the first substrate;
a liquid crystal composition located between the first substrate and the second substrate;
wherein the liquid crystal composition comprises one or more regions of polymerised liquid crystal composition; and
a first electrode and a second electrode configured to apply the electric field;
comparing a display output by the liquid crystal device in response to the application of the electric field to the verification code associated with the product;
wherein, if the display output by the liquid crystal device matches the verification code associated with the product, the product is authenticated.

2. The method of claim 1, wherein the first substrate is rubbed in a first direction, the second substrate is rubbed in a second direction, and the first direction and the second direction are anti-parallel.

3. The method of claim 1, wherein the first substrate is rubbed in a first direction, the second substrate is rubbed in a second direction, and the first direction and the second direction are parallel.

4. The method of claim 1, wherein the first substrate is rubbed in a first direction, the second substrate is rubbed in a second direction, and the rubbing directions are:
i) weakly skewed with respect to the first direction with an angular offset between the first and second orientation of less than 10 degrees or less than 45 degrees;
ii) weakly twisted, with an angular offset of at least 45 degrees between the first and second orientation;
iii) twisted nematic, with an angular offset of 90 degrees between the first and second orientation;
iv) supertwisted, with an angular offset of greater than 90, 180, 240, or 270 degrees between the first and second orientation.

5. The method of claim 1, wherein the liquid crystal composition may comprise a homogeneous alignment, a homeotropic alignment, or a hybrid alignment.

6. The method of any preceding claim, wherein the polymerised regions are pillars extending partially or fully between the first substrate and second substrate.

7. The method of any preceding claim, wherein the polymerised regions are spaced apart by a distance of at least 2 μm, and optionally spaced apart by a distance of at least 5 μm.

8. The method of any preceding claim, wherein one or more of the polymerised regions are polymerised under the application of an electric field, and optionally wherein different polymerised regions are polymerised under the application of different electric field strengths.

9. The method of any preceding claim, wherein the polymerised regions are configured to be optically invisible under the application of a pre-determined electric field strength, and optionally wherein the polymerised regions are configured to be optically invisible under both polarised light and unpolarised light.

10. The method of any preceding claim, wherein the verification code is one of a bar code, a QR code, a pattern or an image.

11. The method of any preceding claim, wherein the verification code is a sequence of verification codes, and the electric field is a sequence of electric fields.

12. A liquid crystal device comprising;
a first substrate rubbed in a first direction;
a second substrate space apart from the first substrate and rubbed in an anti-parallel direction to the first substrate;
a liquid crystal composition located between the first substrate and the second substrate;
wherein the liquid crystal composition comprises one or more regions of polymerised liquid crystal composition; and
a first electrode and a second electrode configured to produce an electric field.

13. The device of claim 12, wherein the polymerised regions are pillars extending partially or fully between the first substrate and the second substrate.

14. The device of claim 12 or claim 13, wherein the polymerised regions are spaced apart by a distance of at least 2 μm, and optionally spaced apart by a distance of at least 5 μm.

15. The device of any one of claims 12 to 14, wherein one or more of the polymerised regions is polymerised under the application of an electric field, and optionally wherein different polymerised regions are polymerised under the application of different electric field strengths.

16. The device of any one of claims 12 to 15, wherein the polymerised regions are configured to be optically invisible under the application of a pre-determined electric field strength, and optionally wherein the polymerised regions are configured to be optically invisible under both polarised light and unpolarised light.

17. The device of any one of claims 12 to 16, wherein the liquid crystal composition comprises a nematic liquid crystal material having a positive or a negative dielectric anisotropy, a chiral nematic liquid crystal material, or a smectic A liquid crystal material.

18. A method of electrically controlling optical visibility of polymeric structures, the method comprising:
applying an electric field to a liquid crystal device, the liquid crystal device comprising:
a first substrate rubbed in a first direction;
a second substrate space apart from the first substrate and rubbed in an antiparallel direction to the first substrate;
a liquid crystal composition located between the first substrate and the second substrate;
wherein the liquid crystal composition comprises one or more regions of polymerised liquid crystal composition forming polymer structures; and
a first electrode and a second electrode configured to apply the electric field;
wherein the polymer structures are configured to be optically invisible under the application of a pre-determined electric field strength.

19. The method of claim 18, wherein one or more of the polymerised regions is polymerised under the application of an electric field, and optionally wherein different polymerised regions are polymerised under different electric field strengths.

20. The method of claim 18 or claim 19, wherein the polymerised regions are configured to be optically invisible under both polarised light and unpolarised light.

21. The method of any one of claims 18 to 20, wherein the polymerised regions are pillars extending partially or fully between the first substrate and the second substrate.

22. The method of any one of claims 18 to 21, wherein the polymerised regions are spaced apart by a distance of at least 2 μm, and optionally spaced apart by a distance of at least 5 μm.

23. A verification device for verifying a security marking comprising a liquid crystal device, the verification device comprising:
an optical detector configured to detect a display output by the liquid crystal device;
a memory containing a verification code associated with the security marking;
a processor, the processor configured to:
perform a comparison between the display output by the liquid crystal device and the verification code stored in the memory; and
verify the security marking if the display output by the liquid crystal device matches the verification code stored in the memory.

24. The verification device of claim 23, wherein the optical detector is one of a camera, a charge-coupled device, a raster-scanning laser detector, and a photodiode detector.

25. The verification device of claim 23 or claim 24, further comprising a power source configured to supply power to the liquid crystal device in order for the liquid crystal device to output a display.
